(19) United States
(12) Patent Application Publication
(10) Pub. No.: US 2017/0158063 A1
(43) Pub. Date: Jun. 8, 2017

(54) WIRELESS CHARGING SYSTEM FOR VEHICLE

(71) Applicant: HYUNDAI MOTOR COMPANY, Seoul (KR)

(72) Inventors: Sung Hoon LIM, Gunpo-si (KR); Sang Mok PARK, Seongnam-si (KR); Sang Heon LEE, Yongin-si (KR); Dong Hui KIM, Suwon-si (KR); Shin Kook KONG, Seoul (KR)

(21) Appl. No.: 15/091,154

(22) Filed: Apr. 5, 2016

(30) Foreign Application Priority Data
Dec. 4, 2015 (KR) 10-2015-0172166

(51) Int. Cl. B60L 11/18

(52) U.S. Cl. CPC B60L 11/182; B60L 11/1875

(57) ABSTRACT

A wireless charging system for a vehicle includes a wireless power receiver receiving electric power wirelessly. A heat transfer device transferring heat generated from the wireless power receiver. A rechargeable battery is charged with the electric power received from the wireless power receiver and heated by receiving the heat that is transferred by the heat transfer device.

### CROSS REFERENCE TO RELATED APPLICATION

The present application claims the benefit of priority to Korean Patent Application No. 10-2015-0172186, filed on Dec. 4, 2015, the entire content of which is incorporated herein for all purposes by this reference.

### TECHNICAL FIELD

The present disclosure generally relates to a wireless charging system for a vehicle. More particularly, the present disclosure relates to a wireless charging system for a vehicle, capable of improving charging efficiency of received electric power.

### BACKGROUND

Generally, wireless charging technology is a technology for wirelessly transmitting electric power to charge a battery without contact between a charging device and respective contact terminals of the battery.

The wireless charging technology has been used to charge low-capacity batteries of portable electric devices, such as a mobile phone and a personal digital assistant (PDA). However, new technologies are currently under development for an application that requires high electric power transmission, for example, charging a battery applied to an electric vehicle or a plug-in hybrid electric vehicle.

The principle of the wireless charging technology is to transmit and receive electric power using electromagnetic induction or resonance. In order to realize this, a wireless charging device having respective coils in both a power transmit unit and a power receive unit should be provided. In particular, the wireless charging device for charging ab electric vehicle or a plug-in hybrid electric vehicle requires a high-capacity battery, and thereby, requires high electric power transmission in order to reduce a charging time of the battery. Thus, the wireless charging device may generate much heat have a relatively large size.

Conventionally, heat generated from a wireless charging system has been considered as an energy loss, so that research and development have focused on a method of dissipating the heat efficiently.

The foregoing is intended merely to aid in the understanding of the background of the present disclosure, and is not intended to mean that the present disclosure falls within the purview of the related art that is already known to those skilled, in the art.

### SUMMARY

The present disclosure has been made keeping in mind the above problems occurring in the related art. An aspect of the present disclosure provides a wireless charging system for a vehicle, capable of improving charging efficiency of received electric power using heat generated from a wireless charging receiver that receives electric power wirelessly during battery charging of the vehicle.

According to one exemplary embodiment in the present disclosure, a wireless charging system for a vehicle includes: a wireless power receiver receiving electric power wirelessly; a heat transfer device transferring heat generated from the wireless power receiver; and a rechargeable battery being charged with the electric power received from the wireless power receiver and receiving the heat transferred by the heat transfer device.

The heat transfer device may include a heat sink disposed to be in contact with the wireless power receiver and dissipating the heat generated from the wireless power receiver.

The heat transfer device may include a fan generating airflow in a direction from the wireless power receiver to the rechargeable battery.

The rechargeable battery may be an all solid battery.

The wireless charging system may further include an electric heating coil disposed between the heat transfer device and the rechargeable battery.

According to another embodiment in the present disclosure, a wireless charging system for a vehicle includes: a wireless power receiver receiving electric power wirelessly; a heat sink disposed to be in contact with the wireless power receiver and dissipating heat generated from the wireless power receiver; a fan generating airflow in order to transfer heat dissipated from the heat sink to air; and an all solid battery being charged with the electric power received from the wireless power receiver and being heated by the heat transferred via the airflow that is generated by the fan.

The wireless charging system may further include an electric heating coil disposed between the fan and the all solid battery.

According to the wireless charging system for a vehicle configured as described above, an all solid battery is heated enough to realize optimum charging temperature using thermal energy that is generated from the wireless power receiver, whereby it is possible to improve charging performance of the all solid battery.

Thus, according to the wireless charging system for a vehicle of the present disclosure, it is possible to reduce a time to fully charge the all solid battery and to improve reliability and marketability of a vehicle.

### BRIEF DESCRIPTION OF THE DRAWINGS

FIG. 1 is a block diagram illustrating technical concepts of a wireless charging system for a vehicle according to an embodiment in the present disclosure.

FIG. 2 is a diagram illustrating the wireless charging system for a vehicle according to an embodiment in the present disclosure

FIG. 3 is a view illustrating energy flow and power charging when charging a vehicle with power wirelessly using the wireless charging system for vehicle according to the embodiment in the present disclosure.

### DETAILED DESCRIPTION

Hereinbelow, exemplary embodiments in the present disclosure will be described in detail with reference to the accompanying drawings. Throughout the drawings, the same reference numerals will refer to the same or like parts.

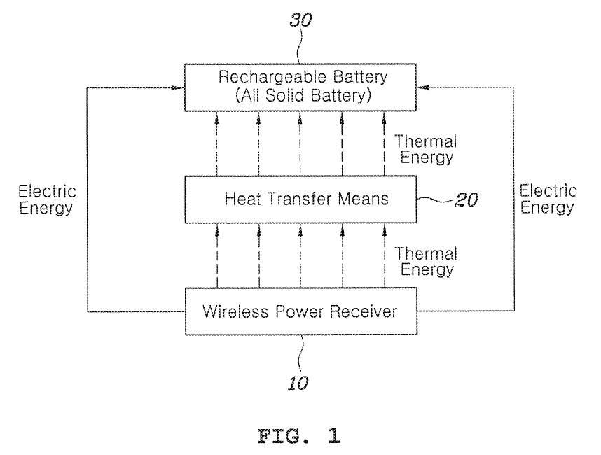

FIG. 1 is a block diagram illustrating a technical concept of a wireless charging system for a vehicle according to an embodiment in the present disclosure.

As shown in FIG. 1, a wireless charging system for a vehicle according to the present disclosure includes a wireless power receiver 10, a heat transfer device 20, and rechargeable battery 30. The solid arrow in FIG. 1 refers to a flow of electrical energy, and the dotted arrow in FIG. 1 refers to a flow of thermal energy.

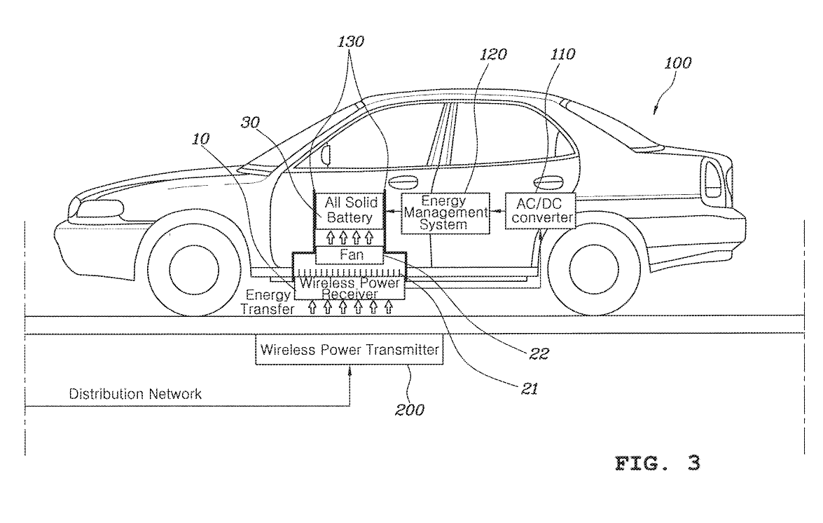

The wireless power receiver 10 receives electric power from a wireless power transmitter 200 (see FIG. 3) of the wireless charging system for a vehicle. In the wireless charging system, the wireless power transmitter 200 and the wireless power receiver 10 may include respective coils which are electromagnetically coupled to each other. That is, the coil that is provided in the wireless power transmitter 200 creates a magnetic field using commercial alternating current power transmitted thereto via a distribution network, and the coil that is provided in the wireless power receiver 10 generates electric power that is induced by the magnetic field created by the wireless power transmitter 200, thereby enabling wireless power transmission and reception.

During the wireless power transmission and reception, the wireless power transmitter 200 and the wireless power receiver 10 generate a large amount of heat as an energy loss during electromagnetic coupling.

In the wireless charging system according to the present disclosure, heat is generated while charging a vehicle and is used to improve efficiency of the vehicle battery which powers a motor. In other words, the heat generated from the wireless power receiver 10, which is provided in the vehicle, is used to heat the battery to an appropriate temperature to optimize battery charging efficiency.

The heat transfer device 20 is provided for transferring the heat generated from the wireless power receiver 10 to the rechargeable battery 30. In other words, the heat transfer device 20 may orient a flow direction of thermal energy produced by the heat, which is generated from the wireless power receiver 10, toward the rechargeable battery 30.

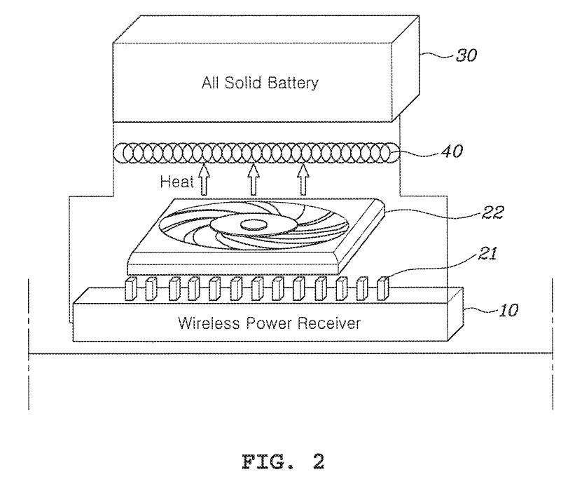

The heat transfer device 20 may include a heat sink 21 (see FIG. 2) made of a material having good thermal conductivity or a fan 22 (see FIG. 2) that produces airflow.

The rechargeable battery 30 is provided for receiving the electric power from the wireless power receiver 10 and storing the power. Here, the rechargeable battery 30 may be an all solid battery.

The all solid battery has solid electrolytes, which allow ions to travel there through. A lithium-ion battery is used as conventional rechargeable battery, wherein a cathode of the lithium-ion battery is separated from an anode thereof by a separator. The lithium-ion battery can pose a safety hazard such as a fire or an explosion since heat is produced by encounter between the anode and the cathode when the separator is damaged by shock, etc., whereby heated electrolytes transform into gases. On the contrary, the all solid battery has electrolytes with no liquids, thereby having high resistance to shock.

Further, a lithium polymer battery, which is widely used for a conventional high-voltage battery of a vehicle, can have degraded performance or efficiency and can pose a safety hazard, such as a fire or an explosion, under high temperature. Thus, the lithium polymer battery requires heat management system of the battery. On the contrary, the all solid battery is safe under high temperature, thereby requiring no heat management system. In addition, the higher the temperature of the battery is, the better ion conductivity and charging efficiency thereof are.

Therefore, the rechargeable battery 30 may be an all solid battery so that the charging efficiency can be improved by the heat transferred via the heat transfer device 20. The all solid battery 30 can be heated to a temperature that can realize optimum charging efficiency, for example, around 70 to 80° C., by receiving the heat that is generated from the wireless power receiver 10 and transferred via the heat transfer device 20.

FIG. 2 is a diagram illustrating the wireless charging system for a vehicle according to the embodiment in the present disclosure.

As shown in FIG. 2, the wireless charging system for a vehicle may include a wireless power receiver 10 for receiving electric power wirelessly; a heat sink 21 for dissipating heat generated from the wireless power receiver by being in close contact with the wireless power receiver 10; a fan 22 for generating airflow in order to transfer heat dissipated from the heat sink to air; and an all solid battery 30 for being charged with the electric power received from the wireless power receiver 10 and for being heated by the heat transferred via the airflow that is generated by the fan 22. The wireless charging system for a vehicle according to the present disclosure may further include an electric heating coil 40 disposed between the fan 22 and the all solid battery 30.

The wireless charging system for a vehicle according to the present disclosure, the heat transfer device 20 includes the heat sink 21 and the fan 22.

The heat sink 21 is in close contact with the wireless power receiver 10 and assists dissipates the heat, thereby expanding a contact area, where the heat transferred from the wireless power receiver 10 comes into contact with air. Generally, the heat sink 21 may include a heat sinking plate that is in close contact with the wireless power receiver 10, and a heat sinking fin for expanding a contact area that comes into contact with air.

The wireless charging system for a vehicle according to the present disclosure is configured such that the heat generated from the wireless power receiver 10 is dissipated by the heat sink 21, and the dissipated heat is transmitted to the all solid battery 30. Thus, the heat sink 21 may be provided on a surface of the battery of the wireless power receiver 10.

The fan 22 is provided for generating airflow, wherein the fan 22 is capable of sucking air from one side thereof and releasing the air to another side thereof. According to the present disclosure, the heat dissipated from the heat sink 21 should heat the all solid battery 30 by transmitting the heat to the all solid battery 30, so that the fan 22 is operated and the airflow is produced in a direction from the heat sink 21 to the all solid battery 30.

According to the present disclosure, the wireless charging system for a vehicle further includes the electric heating coil 40. The electric heating coil 40 is provided for generating heat when electric current flows. The electric heating coil 40 is operated when the heat, which is transmitted via the heat transfer device including the heat sink 21 and the fan 22, falls short of sufficiently heating the all solid battery 30

The electric heating coil 40 may be disposed between the fan 22 and the all solid battery 30 so that the all solid battery 30 can be heated by using the airflow produced by the fan 22, which is described hereinbefore.

The heat transfer device 20 includes both the heat sink 21 and/or the fan 22. For example, when the heat transfer device includes only the heat sink 21, the rechargeable battery 30 may be close to or to be in close contact with the heat sink 21.

FIG. 3 is a view illustrating a flow of energy and a concept of charging when charging a vehicle wirelessly using the wireless charging system for a vehicle according to the embodiment in the present disclosure.

As shown in FIG. 3, in order to charge a vehicle wirelessly, a vehicle 100 has a wireless power receiver 10 and the rechargeable battery (all solid battery) 30 and enters a vehicle charging station having a wireless power transmitter 200, and then the wireless power receiver 10 provided at a lower portion of the vehicle 100, and the wireless power transmitter 200 provided on a ground surface of the charging station are aligned to face each other.

The wireless power transmitter 200 that receives alternating current from the distribution network creates a magnetic field, and the wireless power receiver 10 generates electric power that is induced by the magnetic field, thereby enabling power transmission.

Electric power supplied from the wireless power receiver 10 is alternating current, but the alternating current must be changed to direct current in order to charge the rechargeable battery 30. Thus, an AC/DC converter 110 that is provided in the vehicle 100 converts the electric power generated from the wireless power receiver 10, into a direct current, and the converted direct current is transmitted to an energy management system (EMS) 120 of the vehicle. The EMS 120 converts the direct current transmitted from the AC/DC converter 110 into voltage and current that enable the rechargeable battery 30 to be charged, and provides the rechargeable battery 30 with the current. Thereby, the rechargeable battery 30 is capable of being charged with the electric power that the wireless power receiver 10 receives from the wireless power transmitter 200.

Heat is produced while the wireless power receiver 10 generates the alternating current that induced by the magnetic field, and the heat is dissipated in an upward direction of the wireless power receiver 10 by the heat sink 21 that is in close contact with an upper part of the wireless power receiver 10.

The fan 22 is provided in an upper part of the heat sink 21 and produces airflow within a space between the wireless power receiver 21 and the rechargeable battery 30. In other words, the fan 22 generates airflow in a direction from the wireless power receiver 21 to the rechargeable battery 30, thereby providing the rechargeable battery 30 with heat that is generated from the wireless power receiver 10 and dissipated by the heat sink 21.

Referring to FIG. 3, the wireless power receiver 10, the heat sink 21, the fan 22, and the rechargeable battery 30 are sequentially disposed in an up-down direction of the vehicle, that is, a vertical direction of the vehicle. However, arrangements can vary depending on a vehicle interior layout. In other words, the wireless charging system for a vehicle according to the present disclosure may further include a duct 130 for allowing air to flow between the wireless power receiver 21 and the rechargeable battery 30, and the structure of the duct 130 can be changed depending on requirements, thereby forming a desirable structure.

As described above, the wireless charging system for a vehicle according to the embodiments in the present disclosure may improve charging performance of the all solid battery by sufficiently heating the all solid battery to optimum charging temperature using thermal energy that is generated from the wireless power receiver.

Thus, it is possible to reduce a time to fully charge the all solid battery and to improve reliability and marketability of a vehicle that has the wireless charging system.

Although exemplary embodiments have been described for illustrative purposes, those skilled in the art will appreciate that various modifications, additions, and substitutions are possible, without departing from the scope and spirit of the invention as disclosed in the accompanying claims.

What is claimed is:

1. A wireless charging system for a vehicle, the wireless charging system comprising:
a wireless power receiver receiving electric power wirelessly;
a heat transfer device transferring heat generated from the wireless power receiver; and
a rechargeable battery being charged with the electric power received from the wireless power receiver and receiving the heat transferred by the heat transfer device.

2. The wireless charging system of claim 1, wherein the heat transfer device comprises a heat sink disposed to be in contact with the wireless power receiver and dissipating the heat generated from the wireless power receiver.

3. The wireless charging system of claim 1, wherein the heat transfer device comprises a fan generating airflow in a direction from the wireless power receiver to the rechargeable battery.

4. The wireless charging system of claim 1, wherein the rechargeable battery is an all solid battery.

5. The wireless charging system of claim 1, further comprising:
an electric heating coil disposed between the beat transfer device and the rechargeable battery.

6. The wireless charging system of claim 1, wherein the wireless power receiver receives the electric power induced by a magnetic field from a wireless power transmitter which is disposed on a ground surface of a battery charging station.

7. A wireless charging system for a vehicle, the wireless charging system comprising:
a wireless power receiver configured to receive electric power wirelessly;
a heat sink disposed to be in contact with the wireless power receiver and dissipating heat generated from the wireless power receiver;
a fan generating airflow in order to transfer the heat dissipated from the heat sink to air; and
an all solid battery being charged with the electric power received from the wireless power receiver and being heated by the heat transferred via the airflow that is generated by the fan.

8. The wireless charging system of claim 7, further comprising:
an electric heating coil disposed between the fan and the all solid battery.
